(19) United States
(12) Patent Application Publication
(10) Pub. No.: US 2004/0013580 A1
(43) Pub. Date: Jan. 22, 2004

(54) Open filter body with improved flow properties

(76) Inventors: Rolf Bruck, Bergisch Gladbach (DE); Jan Hodgson, Troisdorf (DE)

Correspondence Address: LERNER AND GREENBERG P.A., Post Office Box 2480, Hollywood, FL, 33022-2480, US

(21) Appl. No.: 10/289,088

(22) Filed: Nov. 6, 2002

(30) Foreign Application Priority Data
Nov. 6, 2001 (DE) 201 17 873.7

(51) Int. Cl. B01J 8/02

(52) U.S. Cl. 422/171; 422/169; 422/170

(57) ABSTRACT

A filter body for cleaning exhaust gases from an internal combustion engine includes at least one filter layer and at least one foil, which are disposed in such a way that channels through which the exhaust gas can flow are formed. The foil is provided with a structure which has a structure height as well as elevations and depressions that extend at least partially in an axial direction. The foil also has a plurality of vanes which have a vane height and in each case form a passage having a vane inlet and a vane outlet. The vane inlet and the vane outlet are disposed at an angle to one another. The filter body is distinguished by the fact that the vane height is between 100% and 60% of the structure height, with a freedom of flow of at least 20% being ensured.

### BACKGROUND OF THE INVENTION

### FIELD OF THE INVENTION

The invention relates to a heat-resistant, regeneratable filter body for cleaning exhaust gases from an internal combustion engine. The filter body includes at least one filter layer and at least one foil, which are disposed in such a way that channels through which the exhaust gas can flow are formed. The foil is provided with a structure which has a structure height as well as elevations and depressions that extend at least partially in an axial direction. Furthermore, the foil has a plurality of vanes with a vane height, which in each case form a passage having a vane inlet and a vane outlet. The vane inlet and the vane outlet are disposed at an angle to one another. Filter bodies of that type are used in particular in the exhaust systems of mobile internal combustion engines used in automotive engineering.

If one considers new registrations in Germany, for example, it will be observed that in the year 2000 around one third of all newly registered vehicles had diesel engines. That proportion is traditionally significantly higher, for example, than in France and Austria. That increased interest in diesel vehicles can be traced back, for example, to relatively low fuel consumption, currently relatively low price of diesel fuel, as well as improved driving properties of such vehicles. A diesel vehicle is also very attractive from an environmental point of view, since it has CO₂ emissions which are considerably reduced as compared to gasoline-driven vehicles. However, it must also be noted that the level of soot particles generated during combustion is considerably above that of gasoline-driven vehicles.

If one then considers the cleaning of exhaust gases, in particular from diesel engines, hydrocarbons (HC) and carbon monoxides (CO) in the exhaust gas can be oxidized in a known way by being brought into contact, for example, with a catalytically active surface. However, the reduction of nitrogen oxides (NOₓ) under oxygen-rich conditions is more difficult. A three-way catalytic converter as is used, for example, in spark-ignition or Otto engines, does not produce the desired effects. The selective catalytic reduction (SCR) process has been developed for that reason. Furthermore, NOₓ adsorbers have been tested for use for nitrogen oxide reduction.

The discussion as to whether or not particles or long-chain hydrocarbons have an adverse effect on human health has now been in progress for a very great length of time without a definitive judgment having been reached to date. Irrespective of that judgment, it is clearly desirable that such emissions should not be released to the environment beyond a certain tolerance range. In that respect, the question arises as to what level of filter efficiency is actually required if it is also to be possible to comply with the statutory directives which have become known to date and even those which will be laid down in the future. If one considers current exhaust emissions from transport vehicles used in the Federal Republic of Germany, it will be found that most of the passenger automobiles which were certified to comply with EU III in 1999 can also satisfy the requirements laid down by EU IV if they are equipped with a filter which has an efficiency of at least 30 to 40%.

It is known to use particle traps which are constructed from a ceramic substrate in order to reduce the levels of particle emissions. Those traps have channels, so that the exhaust gas which is to be cleaned can flow into the particle trap. Adjacent channels are alternately closed, so that the exhaust gas enters the channel on the inlet side, passes through the ceramic wall and escapes again through the adjacent channel on the outlet side. Filters of that type achieve an efficiency of approximately 95% over the entire range of particle sizes which occur.

In addition to chemical interactions with additives and special coatings, reliable regeneration of the filter in the exhaust system of an automobile also still causes problems. It is necessary to regenerate the particle trap, since the increasing accumulation of particles in the channel wall through which the gas has to flow leads to a continuously increasing pressure loss which has adverse effects on the engine output. The regeneration includes, in essence, brief heating of the particle trap and/or the particles which have accumulated therein, so that the soot particles are converted into gaseous constituents. However, that high thermal loading on the particle trap has adverse effects on service life.

In order to avoid such a discontinuous regeneration, which greatly promotes thermal wear, a system has been developed for continuous regeneration of filters (CRT: Continuous Regeneration Trap). In a system of that type, the particles are burnt through the use of oxidation with NO₂ even at temperatures of only above 200° C. The NO₂ required for that purpose is often generated by an oxidation catalytic converter which is disposed upstream of the particle trap. However, in that case, particularly with a view toward use in motor vehicles which use diesel fuel, the problem arises that there is only an insufficient amount of nitrogen monoxide (NO), which can be converted into the desired nitrogen dioxide (NO₂), in the exhaust gas. Consequently, it has not heretofore been possible to ensure that continuous regeneration of the particle trap takes place in the exhaust system.

Furthermore, it is necessary to take into account the fact that, in addition to particles which cannot be converted, oil or additional residues of additives also accumulate in a particle trap and cannot readily be regenerated. For that reason, known filters have to be exchanged and/or washed at regular intervals. Filter systems which have a plate-like structure attempt to solve that problem by allowing vibration-like excitation which leads to those constituents being removed from the filter. However, that leads to the fraction of particles which cannot be regenerated in some cases passing directly into the environment without further treatment.

In addition to a minimum reaction temperature and a specific residence time, it is necessary for sufficient nitrogen oxide to be available for continuous regeneration of particles with NO₂. Tests relating to the dynamic emission of nitrogen monoxide (NO) and particles have clearly demonstrated that the particles are emitted precisely when there is no nitrogen monoxide or only very small amounts of nitrogen monoxide in the exhaust gas, and vice versa. Consequently, a filter with real, continuous regeneration has to function substantially as a compensator or storage device, so that it is ensured that the two reaction partners remain in the filter in the required quantities at a given time. Furthermore, the filter is to be disposed as close as possible to the internal combustion engine, in order to be able to adopt temperatures which are as high as possible even immediately after a cold start. In order to provide the required nitrogen dioxide, an oxidation catalytic converter, which converts carbon monoxide (CO) and hydrocarbons (HC), and in particular also converts nitrogen monoxide (NO) into nitrogen dioxide (NO₂), is to be connected upstream of the filter. If that system including an oxidation catalytic converter and a filter is disposed close to the engine, the position in front of a turbo charger, which is often used in diesel vehicles to increase the charge pressure in the combustion chamber, is particularly suitable.

If one looks at those fundamental considerations, the question arises, for actual use in automotive engineering, of how a filter which provides a satisfactory filter efficiency in such a position and in the presence of extremely high thermal and dynamic loads, is constructed. In particular, account needs to be taken of the spatial conditions, which require a new filter structure. While conventional filters, which are disposed on the underside of a motor vehicle, have required a volume which is as large as possible, in order to ensure a high residence time of the as yet unconverted particles in the filter and therefore a high level of efficiency, if the filter is disposed close to the engine, there is not sufficient space or room available.

For that purpose, a new concept has been developed, which has become known mainly by the term “open filter system”. Those open filter systems are distinguished by the fact that there is no need for the filter channels to be alternately closed off by structural measures. It is provided for the channel walls to be constructed at least in part from porous or highly porous material and for the flow channels of the open filter to have diverting or guiding structures. Those internal fittings lead to the flow or the particles contained therein being diverted toward the regions made from porous or highly porous material. Surprisingly, it has emerged that the particles stick on and/or in the porous channel wall as a result of interception and/or impacting. The pressure differences in the flow profile of the flowing exhaust gas are of importance for that effect to occur. The diversion additionally allows local reduced-pressure or excess-pressure conditions to occur, leading to a filtration effect through the porous wall, since it is necessary to compensate for the above-mentioned pressure differences.

The particle trap, unlike the known, closed screening or filter systems, is open, since there are no blind alleys for the flow. That property can therefore also be used to characterize particle filters of that type so that, by way of example, the parameter “freedom of flow” is suitable for such a description. Therefore, a “freedom of flow” of 20% means that, when considered in cross section, it is possible to see through approximately 20% of the area. In the case of a particle filter with a channel density of approximately 600 cpsi (cells per square inch) with a hydraulic diameter of 0.8 mm, that freedom of flow would correspond to an area of over 0.1 mm².

By way of example, European Patent 0 484 364 B1, corresponding to U.S. Pat. Nos. 5,130,208 and 5,045,403, and German Utility Model G 89 08 738.0, corresponding to U.S. Pat. No. 5,403,559, provide information about the general structure of honeycomb bodies with internal flow-guiding surfaces. Those documents describe honeycomb bodies, in particular catalytic-converter carrier bodies for motor vehicles, including metal sheets which are disposed in layers, are structured at least in partial regions and form walls of a multiplicity of channels through which a fluid can flow. Those documents describe that in most applications and given the standard dimensions of honeycomb bodies of that type, the flow in the channels is substantially laminar, i.e. very small channel cross sections are used. Under those conditions, relatively thick boundary layers, which reduce contact of the core flow in the channels with the walls, are built up on the channel walls. In order to make the flow of exhaust gas inside the channels turbulent and thereby ensure intensive contact of the entire stream of exhaust gas with a catalytically active surface of the channels, those documents propose the use of folds which form surfaces for the fluid to flow onto in the interior of the channel, so that the exhaust gas is diverted transversely to the main direction of flow.

### SUMMARY OF THE INVENTION

It is accordingly an object of the invention to provide an open filter body with improved flow properties, which overcomes the hereinafore-mentioned disadvantages of the heretofore-known devices of this general type and which influences a diversion of exhaust gas flowing through in such a way that effectiveness of the filter body is improved while, at the same time, a significant exhaust-gas back pressure in front of the filter body is to be avoided. Furthermore, the filter body is intended to be heat-resistant and able to withstand high thermal and mechanical loads in an exhaust system of a passenger automobile over a prolonged period of time.

With the foregoing and other objects in view there is provided, in accordance with the invention, a filter body for cleaning exhaust gases from an internal combustion engine. The filter body comprises at least one filter layer and at least one foil together forming channels through which the exhaust gas can flow. These channels preferably extend over the entire length of the filter body. The at least one foil has a structure with a structure height. The structure preferably has a sinusoidal or wavy construction. The structure has elevations and depressions extended at least partially in an axial direction. The at least one foil has a plurality of vanes with a (maximum) vane height. The vane height is between 100% and 60% of the structure height, ensuring a freedom of flow of at least 20%. In this context, configurations with vane heights of between 98% and 70%, in particular between 95% and 80% of the structure height are preferred. Each of the vanes form a passage having a vane inlet and a vane outlet. The vane inlet and the vane outlet are oriented at an angle to one another.

The orientation of the vane inlet and of the vane outlet at an angle to one another in this context means that they are not disposed parallel to one another. The vanes serve the function of at least partially diverting the partial exhaust gas streams which flow through the channels towards the at least one filter layer and/or generating pressure differences in adjacent channels, so that these partial exhaust gas streams, together with the particles contained therein, come into contact with or penetrate through the filter layer. Due to the vanes being formed with a vane inlet and a vane outlet, which are disposed at an angle to one another, by way of example edges for the fluid to flow onto are generated, thereby influencing the direction of flow of the partial exhaust gas streams.

Furthermore, it must be noted that the features of the invention mentioned herein may be used individually or in any desired, suitable combination with one another.

With regard to the freedom of flow, it should be noted that this freedom is preferably greater than 25%, in particular greater than 30%. The term “freedom of flow” will be described with even greater accuracy in this context. The term is to be understood in particular as meaning that the channel has a free channel cross section which is narrowed by the vane and describes a substantially continuous area. This area is generally only split if partial regions of the vane come into contact with opposite channel walls, i.e. if the vane height corresponds the structure height. In this case, two surfaces, which are spaced apart from one another only by the vane and are used to describe the freedom of flow, are formed. For example, a division into three or, under certain circumstances, even more parts is also conceivable, in which case these few partial areas still have a size which is considerably greater, by a multiple, than the size of particles and/or particle agglomerates. In particular, the term does not mean area distributions as in a porous or lattice-like material (sintered materials, metal foams, etc.) which have a multiplicity of apertures or cavities that are delimited from one another and may themselves have a filter effect.

The filter efficiency and the vane geometry are to be taken into account with regard to the structure of a filter body of this type, particularly with a view toward future exhaust directives for passenger automobile exhaust systems, in particular the exhaust-gas mass flow. The mass flow rate in diesel and spark-ignition or Otto engines of relatively new construction is approximately 15 kg/h to 30 kg/h when idling. If secondary air is additionally introduced into the exhaust system in order to ensure sufficient oxidation partners for conversion of the pollutants contained in the exhaust gas, the mass flow rate rises by approximately 15 kg/h to 20 kg/h. The filter efficiency is substantially influenced by the filter material being used. In particular, account is to be taken of the filtering operations, in which diffusion bonding dominates with regard to relatively small particles (in the range from 20 nm to 100 nm), while in the case of larger particles (for example up to 250 nm) the particles primarily accumulate in cavities, pores or the like in the filter material.

In connection with the present invention, particular attention has been directed at the vane geometry, and in this context tests have been carried out to establish the influence of the vane geometry on the efficiency of a filter body of this type, with the pressure drop across the filter body generated by the diversion of the flow also being considered at the same time. Within the context of these investigations, it has surprisingly emerged that the vane height can easily be relatively great, i.e. relatively considerable diversion of the partial gas streams is possible. However, this applies substantially only under the condition that a freedom of flow of at least 20% is nevertheless ensured. To this extent, a suitable vane shape which still ensures a freedom of flow in this channel section of at least 20% is to be selected. By way of example, round, oval, triangular or similar cross-sectional shapes of the vanes are recommended in this concept. The sides of a vane of this type are preferably to be constructed to be steeper than the sides of the structure, so that gas can still flow freely in particular through the edge regions of the adjacent channel sections. In this respect, the invention teaches that it is particularly advantageous for a relatively small number of vanes to be disposed one behind the other in the axial direction, but for these vanes to divert a relatively considerable partial exhaust gas stream. A configuration of this type is surprisingly advantageous in particular with regard to the exhaust-gas back pressure generated by the filter body, in which context current knowledge has been that it has actually been necessary to work on the basis that the internals inside the channels must have a relatively small structure, in order not to unnecessarily increase the exhaust-gas back pressure. To this extent, the proposed configuration of the filter body ensures an improved filter action, while an adverse affect of the drive characteristics on the internal combustion engine is avoided.

In accordance with another feature of the invention, the vanes are disposed in at least a plurality of the elevations and in at least a plurality of the depressions in such a way that the vanes which are directly adjacent in the axial direction are offset with respect to one another in a transverse direction. Accordingly, it has proven particularly advantageous for the vanes to be disposed in the elevations or the depressions. If one considers the foils, the vanes are oriented in such a manner with respect to one another that the vanes disposed in the elevations divert the partial exhaust gas stream out of the channel below toward the elevation, and the vanes disposed in the depressions divert the partial exhaust gas streams from the channel above toward the depressions. The elevations and depressions of the foil are used in particular for bearing on or connection to an adjacent filter layer, so that a diversion of the partial exhaust gas streams described above ensures intimate contact of the diverted partial exhaust gas stream with the filter layer. The vane outlet preferably directly adjoins the corresponding filter layer, and accordingly is disposed parallel to the adjacent filter layer.

In order to explain the vanes which are offset with respect to one another in a transverse direction, it should be noted that this substantially means that, in a channel, there are preferably a plurality of vanes disposed axially behind one another only in the elevations. However, between these vanes in the elevations of one channel at least one vane is disposed in the depression of an adjacent channel. An alternating configuration of vanes of this type does not necessarily have to be formed between two directly adjacent channels. For example, it is also possible for (axial sections of the) channels through which gas can flow freely to be present between these channels with vanes. The alternating configuration is advantageous in particular with regard to the stability of the filter body or of the foil, since the vanes may reinforce the structure, and the uniformly distributed configuration of the vanes leads to a homogeneous rigidity of the filter body. This is also advantageous with regard to the production of foils of this type, since the embossing or stamping of these vanes can be carried out at a certain distance from one another, so that excessive deformation of the foil is avoided. To this extent, material fatigue is prevented, which is important in particular in view of the thermal and dynamic loads in an exhaust system. Furthermore, it should also be taken into account that the foils used to form a filter body of this type are preferably wound and/or turned, so that the structural behavior of the entire foil is also substantially influenced by the configuration of the vanes. The alternating configuration has particularly advantageous properties in this connection, since uniform bending is ensured, and therefore stress peaks with regard to contact on the filter layer are also avoided.

In accordance with a further feature of the invention, the at least one foil is disposed in such a way that, in the radial direction, in each case one vane (belonging to one foil) disposed on an elevation is disposed directly adjacent a vane (belonging to a different, radially adjacent foil) disposed in a depression, and vice versa. This means that two channels which are disposed adjacent one another in the radial direction and are separated only by the filter layer are narrowed simultaneously, with the freedom of flow being ensured in each case close to the filter layer. This firstly leads to the partial exhaust gas streams which flow past the passages delimited by the vanes being able to communicate directly with one another through the filter layer as a result of the pressure changes in this section, so that even in this way intimate contact with the filter material is ensured. On the other hand, configurations of the vanes which are “phase-shifted” in the axial direction significantly improve the mixing efficiency, since the partial gas streams which have already peeled off are practically received by adjacent vanes and are guided into the next filter layer without a considerable loss of pressure. Moreover, this configuration of the vanes allows particularly good fixing of the filter layer if the vane height approximately corresponds to the height of the structure. In this case, the filter layer is fixed by the structure, on one hand, and the opposite vanes which are disposed adjacent one another in the radial direction, on the other hand.

In accordance with an added feature of the invention, the vanes (belonging to one foil) which are offset with respect to one another in the transverse direction have an offset of 2 to 5 mm. This offset is advantageous in particular with regard to the production of foils with vanes of this type. It should also be emphasized that in principle the offset can also be set independently of the configuration of the structure, i.e. there is no need for a vane to be formed in each adjacent elevation or depression. Although this is advantageous with regard to influencing the flow of the exhaust gas, on the other hand it may be necessary to modify the configuration in such a way as to avoid cold work-hardening as a result of the concentrated deformation of the foil, so that the filter body is ensured a service life which is required for use in an exhaust system of an automobile.

In accordance with an additional feature of the invention, with regard to the configuration of the vane inlet, it is advantageous for this inlet to be constructed to be substantially perpendicular to the axial direction. In this case, preferably all of the vanes are disposed in such a way that the flow inlet is disposed in front of the flow outlet, as seen in the axial direction. This means that the vanes are preferably oriented in the same direction, and the vane inlet which is oriented substantially perpendicular to the direction of flow of the exhaust gas diverts a considerable partial exhaust gas stream.

In accordance with yet another feature of the invention, the vane has a collar which is preferably constructed with a collar width of 0.5 to 5 mm. This collar, which is preferably disposed parallel to the direction of flow of the partial exhaust gas streams through the channels, is used to “peel off” partial exhaust gas streams. Furthermore, this collar has a stabilizing function, in order to ensure that an adjoining guide surface has the required stable position. If the exhaust-gas stream from mobile internal combustion engines is considered in more detail, shot-like pressure pulses are detected. The origin of such pulses lies in the combustion operations in the engine and they propagate with the exhaust-gas stream in the direction of flow in an exhaust system. This means that in some cases considerable vibrations occur in a filter body of this type, and endanger in particular such relatively fine structures as the proposed vanes. The collar has distinguished itself in particular over the course of long-term tests in a particularly advantageous way, since it has been possible to considerably reduce or prevent the tendency of guide surfaces of this type to vibrate.

In accordance with yet a further feature of the invention, the vane has a guide surface which preferably has an extent of 1.5 mm to 10 mm, in particular of 2 mm to 5 mm, in the axial direction. In this case, it is particularly advantageous for the guide surface of the vane to form a vane angle with the axial direction which preferably lies in a range of from 15° to 30°, in particular between 20° and 25°. The extent of the guide surface and of the vane angle substantially influence the degree of diversion of partial exhaust gas streams, and therefore have a direct influence on the exhaust-gas back pressure generated by the filter body. The described parameters satisfy demands with regard to influencing the flow, on one hand, and avoidance of an undesirably great pressure drop over the filter body, on the other hand.

In accordance with yet an added feature of the invention, the at least one guide surface has at least one additional aperture, which is preferably constructed to be smaller than the vane inlet and/or the vane outlet. Constructing the guide surface in this way is advantageous in particular in filter bodies which, for example, are regenerated discontinuously. This means that the filter layer initially, over a certain time, accumulates or incorporates increasing numbers of particles, before the solids are converted into gaseous components. In this case, it is possible that the permeability of the filter layer to the exhaust gas may fall as the loading increases. If the exhaust gas is then diverted onto filter sections which have already become “blocked”, an increased back pressure would occur. This phenomenon is reduced by the aperture, since the partial gas stream which has peeled off can at least in part leave the passage defined by the vane again through the aperture. Furthermore, turbulence is generated downstream of this guide surface in the channel, and this turbulence in turn leads to intimate contact of partial exhaust gas streams with the filter layer.

In accordance with yet an additional feature of the invention, the structure of the foil has a structure width, besides the structure height, and the ratio of structure width to structure height lies in a range between 1 and 3. In this context, it should be noted that the vane height is preferably constructed to be larger (for example between 100% and 80% of the structure height) if there is a relatively high ratio of structure width to structure height (for example in the range between 2 and 3). If there are relatively narrow channels, the ratio is, for example, between 1 and 2, and therefore, with a view toward ensuring a freedom of flow of at least 20%, the vane height is to be constructed to be smaller (for example in a range of from 80% to 60% of the structure height).

In accordance with again another feature of the invention, at least four and in particular at least six vanes are disposed in the axial direction. These vanes are preferably at a distance of from 5 to 30 mm from one another. In this context, it should be noted that the number of vanes in the axial direction is also substantially dependent on the length of the filter body. As has already been stated above, in the present case a relatively great vane height compared to the structure height is proposed, so that only a relatively small number of vanes have to be disposed in succession in the axial direction in order to ensure a very effective filter action. Accordingly, in particular the number of vanes per channel or foil length is to be limited to, for example, fewer than 15 vanes, in particular fewer than 10 vanes in succession.

In accordance with again a further feature of the invention, the at least one foil of the filter body has a foil thickness of less than 0.06 mm and preferably is formed of a corrosion-resistant and heat-resistant material, in particular metal. Particularly in the case of highly dynamic filters, which are therefore exposed to very greatly varying ambient conditions, it may be advantageous for the surface-specific heat capacity of the foils to be reduced further, so that they preferably have a foil thickness of less than 0.03 mm, in particular less than 0.015 mm. In this context, foils which are made from a steel that contains aluminum and chromium and in which other components such as, for example, nickel or the like, may also be present, have proven particularly successful.

In accordance with again an added feature of the invention, the at least one filter layer has a mean porosity of between 50% and 95%, in particular between 75% and 90%. The porosity which is actually to be selected is to be selected specifically according to the internal combustion engine or the exhaust-gas stream which it generates. With regard to the different accumulation and filtering effects, in this context the mass flow rate which is generated and the particle sizes contained in the exhaust gas are of crucial importance. If the fraction of particles which have a particle size of greater than 150 mm predominates, the porosity is preferably selected to be in the range between 80% and 95%. However, if considerably smaller particles are present, it is preferable to use a porosity of between 75% and 85%.

In accordance with again an additional feature of the invention, the at least one filter layer has a filter layer thickness of 0.2 mm to 1.5 mm. This layer is preferably formed of a fiber material with a mean diameter of 5 μm to 20 μm. In principle, it should be noted in this context that a filter layer of this type can be produced from a wide range of different materials or combinations of materials. By way of example, it is possible to use knitted or woven wire fabric, metal foams, porous ceramic layers or the like. Fiber materials which are made from a heat-resistant, in particular ceramic material are particularly preferred, and the mean fiber diameter referred to has proven particularly useful with a view toward diffusion bonding of soot particles, which occur during the combustion of diesel fuel.

In accordance with still another feature of the invention, the at least one filter layer and the at least one foil are stacked and/or wound in such a way that a honeycomb body is formed. This honeycomb body is at least partially surrounded by a housing. The honeycomb structure has already proven to be particularly robust and stable for the production of metallic catalyst carrier bodies with regard to the dynamic loads which occur in exhaust system components of this type.

The components which form the honeycomb structure are preferably connected to one another through the use of a joining technique, in particular by brazing, welding or sintering. In order to secure this assembly of filter layers and foils, the honeycomb body is advantageously likewise connected to the housing through the use of a joining technique, in particular likewise through the use of brazing or welding. The connections made through the use of a joining technique are to be executed in such a way that it is possible to compensate for any difference in the coefficient of thermal expansion between the honeycomb body and the housing. By way of example, joining connections which are not formed over the entire axial length of the filter body are suitable for this purpose.

In accordance with still a further feature of the invention, the volume of the filter body is limited in such a way that the volume lies in a range of from 0.01 liters (1) to 1 liter (1), but in particular is constructed to be less than a displacement volume of the internal combustion engine. With regard to the volume of the filter body, it should first of all be noted in this connection that the cited range is very small as compared to the filter bodies which are known from the prior art. Extremely small filter bodies are preferably to be disposed in the immediate vicinity of the internal combustion engine, in order to allow continuous regeneration of the filter body (CRT method). In this context, the term volume of the filter body is to be understood as meaning in particular the volume of the honeycomb body which is composed of the volumes of the at least one filter layer, of the at least one foil and of the channels through which the exhaust gas flows. The displacement volume of the internal combustion engine is based on the total volume of the combustion chambers (cylinders), which is known to lie in a range of from 0.2 l to 4.2 l (engines with 2, 3, 4, 5, 6, 8 or 12 cylinders).

In accordance with still an added feature of the invention, the filter body has a length and a diameter, and the ratio of length to diameter is between 0.5 and 2.5. In this context, a ratio of length to diameter of between 1 and 2 is preferred. Filter bodies according to the invention with a length in the range of from 10 mm to approximately 200 mm are preferred.

In accordance with a concomitant feature of the invention, the filter body has a channel density which is between 50 and 500 cpsi (cells per square inch). To this extent, the channel densities proposed herein are well below the channel densities which are used, for example, in metallic catalyst carrier bodies of the most recent generation. This measure is taken in particular with a view toward the internals disposed in the channels, guaranteeing that a freedom of flow of at least 20% is ensured even when filter bodies of this type are produced on a large series scale.

Other features which are considered as characteristic for the invention are set forth in the appended claims.

Although the invention is illustrated and described herein as embodied in an open filter body with improved flow properties, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional view of a channel in transverse direction;

FIG. 2 is a sectional view of a channel in longitudinal direction, which is taken along a line II-II of FIG. 1, in the direction of the arrows;

FIG. 3 is a perspective view of a phase-shifted configuration of vanes belonging to adjacent foils;

FIG. 4 is a diagram illustrating mixing efficiency;

FIG. 5 is a fragmentary, perspective view showing a structure of a filter body;

FIG. 6 is an enlarged, fragmentary, perspective sectional view which shows a portion of a filter body according to the invention;

FIG. 7 is a partly broken-away, end-elevational view illustrating an embodiment of the filter body according to the invention;

FIG. 8 is an end-perspective view of a further embodiment of the filter body; and

FIG. 9 is a side-elevational view of a structure of a mobile exhaust system.

### DESCRIPTION OF THE PREFERRED EMBODIMENTS

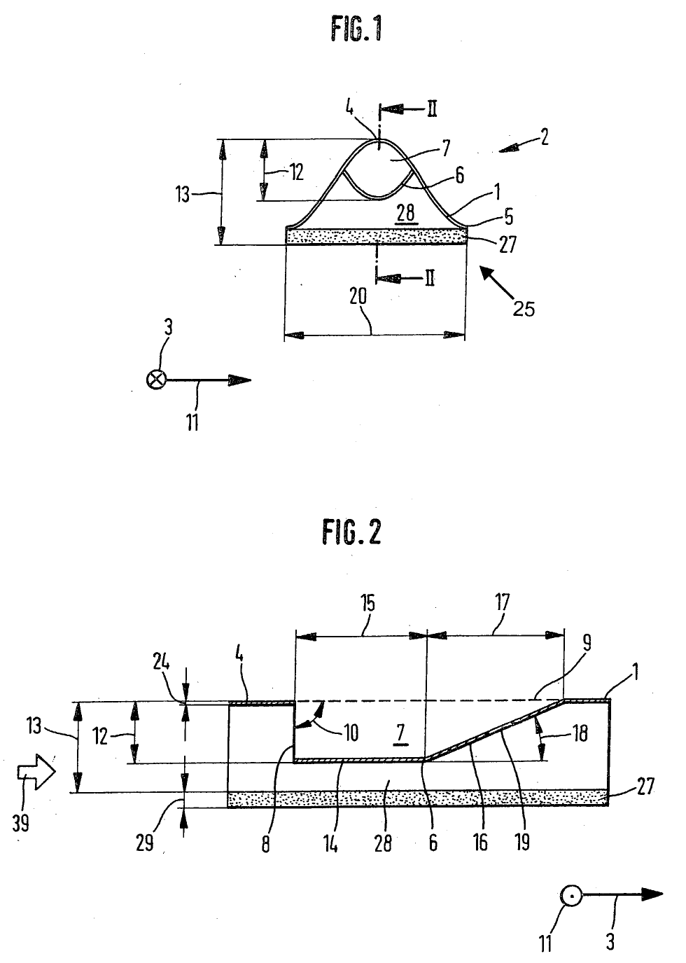

Referring now to the figures of the drawings in detail and first, particularly, to FIG. 1 thereof, there is seen a diagrammatic, cross-sectional view, in a transverse direction 11, through a filter body 25 having a channel 28 which is delimited by a foil 1 and a filter layer 27. The foil 1 is formed with a structure 2 which is a shaping that has a substantially sinusoidal profile with elevations 4 and depressions 5 and is used to space apart adjacent filter layers 27 and to generate the channels 28. The structure 2 has a structure height 13 and a structure width 20. The structure 2 illustrated in this figure has a vane 6, in the elevation 4, which is formed toward the filter layer 27 and delimits a passage 7. The vane 6 has a vane height 12 which is between 100% and 60% of the structure height 13, ensuring a freedom of flow of at least 20%. The freedom of flow substantially describes a ratio of a total channel cross section (in a region without the vane 6) to a reduced cross section of the channel 28 which is still available for the exhaust gas to flow through the channel 28 in addition to the passage 7. A further description of the vane 6 is given with reference to FIG. 2, which shows a section in axial direction 3 through the channel 28, in a plane indicated by dashed lines.

Accordingly, FIG. 2 shows a longitudinal section through a channel 28 in the axial direction 3. In this case too, it can be seen that the channel is substantially delimited by a foil 1 and a filter layer 27. A vane 6 starts from the elevation 4 and extends into the interior of the channel 28. This vane 6 has the vane height 12 and forms the passage 7 with a vane inlet 8 and a vane outlet 9. The vane inlet 8 and the vane outlet 9 are disposed at an angle 10 with respect to one another which is preferably between 70 and 110°, in particular 90°. The vane 6 has a collar 14 with a collar width 15 and a guide surface 16 which has an extent 17 in the axial direction 3. The guide surface 16 of the vane 6 includes a vane angle 18 with the axial direction 3, which is preferably in a range from 15° to 30°. Moreover, the guide surface 16 has an additional aperture 19, which is constructed to be smaller than the vane inlet 8 or the vane outlet 9. In the illustrated, particularly preferred embodiment of the aperture 19, the latter is disposed in a central region of the guide surface 16, i.e. for example centrally with respect to the vane height 12. The aperture 19 itself may adopt various forms, for example as a slot, a hole or the like. The vane height 12 in this case is likewise approximately 80% of the structure height 13. The foil 1 is constructed with a foil thickness 24 which is preferably less than 0.06 mm. The filter layer 27 has a filter layer thickness 29 which is preferably in a range between 0.5 mm and 1.5 mm.

In the illustrated longitudinal section, it can very clearly be recognized that an exhaust-gas stream is guided in the channel 28 in a direction of flow 39 until it meets a vane 6. Part of the exhaust-gas stream is separated off and passes to the vane outlet 9 through the passage 7 and/or with the aid of the guide surface 16. Usually, the elevation 4 of the sheet-metal foil 1 bears directly against a further non-illustrated filter layer 27, so that the partial gas stream which has been separated out of the channel 28 opens directly into a filter layer 27 of this type. Furthermore, it is ensured that a further partial gas stream, in particular a smaller partial gas stream, flows past the vane 6 between the collar 14 and the illustrated filter 27 (i.e. it remains in the channel 28). Reducing the cross section may lead to pressure conditions in the interior of the channel 28 at that location changing in such a way that intensive contact between the flowing partial gas stream and the filter layer 27 occurs in particular in the region of the collar 14.

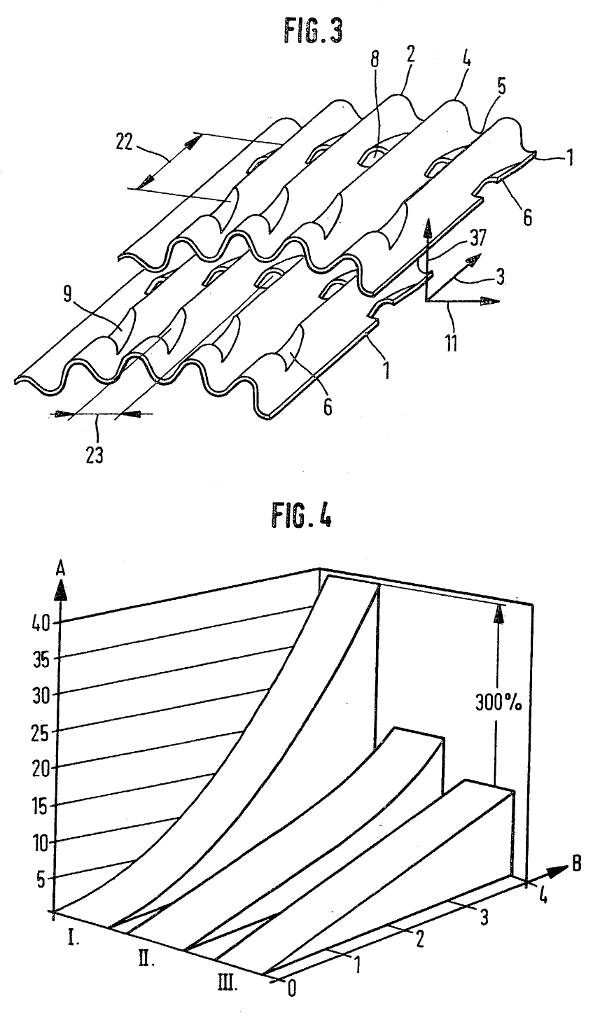

FIG. 3 shows a diagrammatic, perspective illustration of a configuration of two foils 1 with vanes 6 which are disposed at a distance from one another in radial direction 37 in the filter body according to the invention. The filter layer 27 disposed therebetween is not illustrated in this figure. The foils 1 in turn have the structure 2 with elevations 4 and depressions 5, which preferably extend over the entire length in the axial direction 3. The vanes 6 of a foil 1 are disposed alternately and are oriented in the same direction. In this context, the term “alternately” means that the vanes 6, as seen in the axial direction 3, alternately extend upward and downward, with respect to the structure 2 of the foil 1. In the present context, the term “oriented in the same direction” means that the vane inlets 8 of all of the vanes 6 face in one direction, (in particular in the axial direction 3 or opposite thereto), i.e. precede the vane outlet 9 or delimit it in the upstream direction. The vanes 6 are disposed in a plurality of the elevations 4 and in a plurality of the depressions 5, in such a way that the directly adjacent vanes 6 in the axial direction 3 are offset with respect to one another in the transverse direction 11. This offset 23 is preferably between 2 and 5 mm. As seen in the axial direction 3, the vanes 6 disposed one behind the other are spaced apart by a distance 22 of 5 to 30 mm. The vanes 6 of the foils 1 disposed adjacent one another also have a “phase shift”. This means that, in the radial direction 37, in each case one vane 6, belonging to one foil, disposed on an elevation 4 is disposed directly adjacent a vane 6, belonging to a further foil, disposed in a depression 5, and vice versa. If only one foil 1 is used to produce the filter body (for example in helical form), the vanes 6 in the foil 1 are to be formed in such a way that a winding operation leads to a corresponding configuration of the radially adjacent vanes 6. The phase shift preferably corresponds to the distance 22 between two vanes 6 which are adjacent in the axial direction, with an alternating configuration of the vanes 6.

FIG. 4 is a diagram which expresses the particular advantages of a configuration in which the foils 1 alternate, are oriented in the same direction and are phase-shifted. An axis which is denoted by reference symbol “A” shows the number of adjacent channels through which partial gas streams of an exhaust-gas stream, which has been introduced into a single (centrally disposed) channel, flow as a result of different configurations of the foils 1. An axis which is indicated by reference symbol “B” shows the number of vanes which are disposed in succession in the axial direction in a corresponding filter body. A curve illustrated by reference symbol I. corresponds to the structure of a filter body with foils as indicated in FIG. 3 (alternating, oriented in the same direction, phase-shifted). A curve which is denoted by reference symbol II. shows the mixing effect in a filter body which is likewise constructed with metal foils having vanes that alternate and are oriented in the same direction, but with the foils disposed in the same phase. The example which is indicated by reference symbol III. shows the mixing effect for a filter body which has foils with vanes on one side which are oriented in the same direction (therefore, the vanes extend only in one direction starting from the structure, for example all extend downward starting from the elevations or all extend upward extending from the depressions), in which a configuration with an identical phase has been selected for this example too.

It can now be seen from the diagram that, for the example which is denoted by reference symbol III., with four vanes disposed one behind the other, only 13 adjacent channels are involved, i.e. the gas only flows through a corresponding number of filter layers. By contrast, in the filter body shown in Example I., after four vanes disposed in succession in the axial direction, thirty-nine channels are involved, so that the gas also penetrates through a correspondingly higher number of filter layers. This leads to a significant improvement in the efficiency of filtering since, particularly with small particle sizes, the diffusion operations predominate over accumulation and accordingly the largest possible filter surface area has to be provided.

FIG. 5 shows an exploded illustration of the configuration of a foil 1 between two filter layers 27. The filter layers 27 are preferably substantially smooth, i.e. do not have a macrostructure resembling that of the foil 1. FIG. 5 also illustrates how the direction of flow 39 of the partial gas streams is influenced by the vanes 6, with diversion (secondary flow) toward the filter layer 27 always being desired.

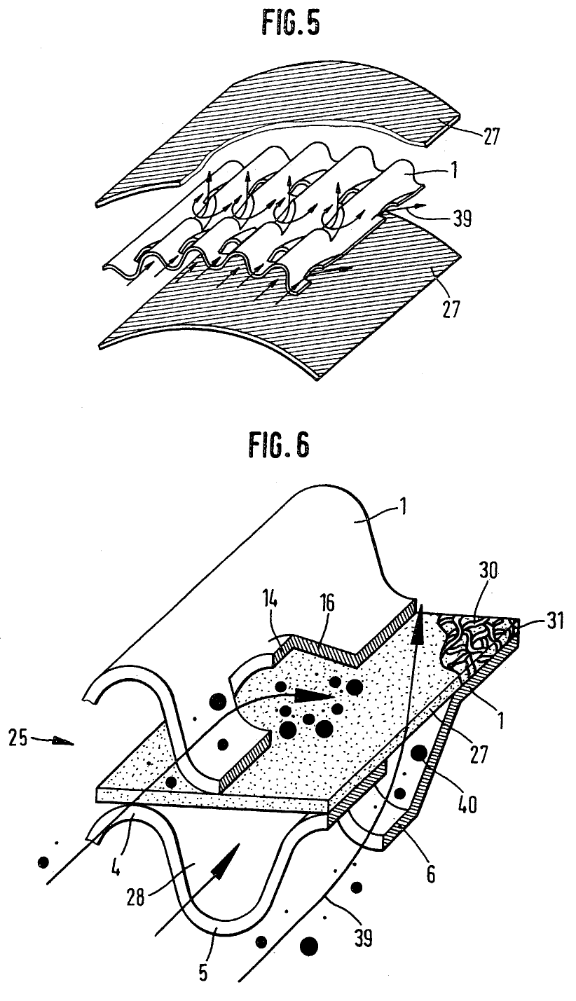

FIG. 6 shows a fragmentary view of an embodiment of a filter body 25 according to the invention in perspective and in section. Two foils 1 disposed adjacent one another, between which there is a fiber layer 27, are illustrated. The fiber layer 27 has a fiber material 30 with fibers which have a fiber diameter 31. In order to divert the direction of flow 39, the vanes 6 of the foils 1 in each case have one collar 14 and one guide surface 16. This ensures that the exhaust gas with particles 40 contained therein penetrate through the filter layers 27, so that the particles 40 are retained on the surface or in the interior of the fiber layer 27 until they can be converted into gaseous components. Discontinuous regeneration (supply of heat) or regeneration using the CRT method may be used for this purpose. The residence time of the particles in the filter body is advantageously extended until the required reaction partners for chemical conversion are present. Moreover, the foils 1 are constructed with a structure 2 which has elevations 4 and depressions 5, so that the channels 28 through which the exhaust gas can flow are formed. In this context, it is preferred for connections produced at least in part through the use of a joining technique to be used in the region of the contact surfaces of the foil 1 and a fiber layer 27, ensuring a permanent connection between these components.

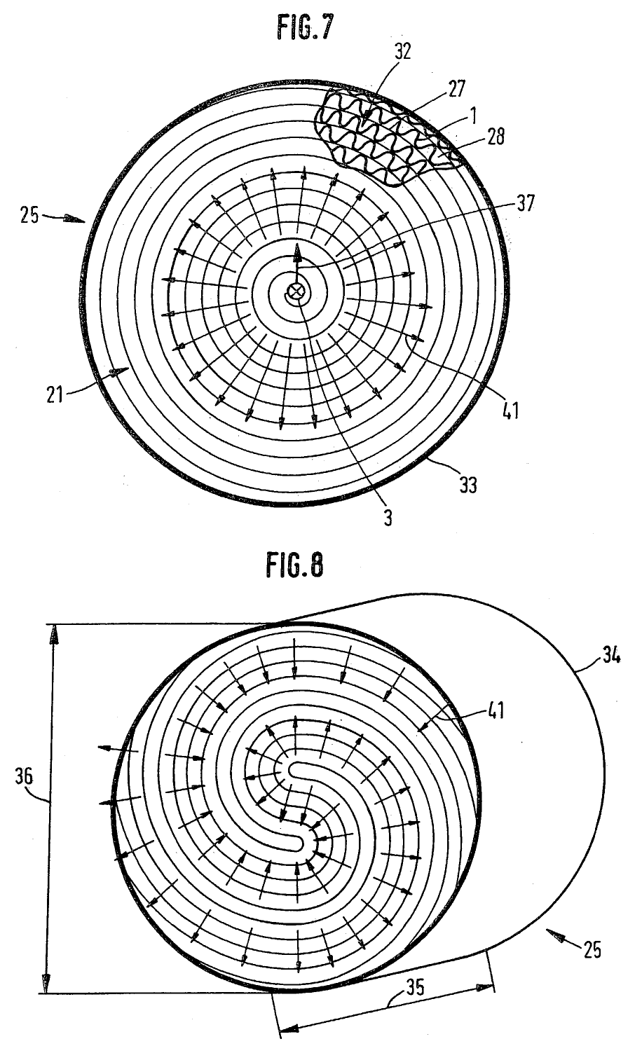

FIG. 7 shows an end-elevational view of an embodiment of the filter body 25 according to the invention. The filter body 25 includes a filter layer 27 and a foil 1, which are stacked and wound in such a way that a honeycomb body 32 is formed. The honeycomb body 32 has channels 28 through which an exhaust gas can flow. The honeycomb body 32 is substantially cylindrical, as a result of the foil 1 having been wound helically together with the fiber layer 27. The honeycomb body 32 produced in this way was inserted into a housing 33 and connected to the latter, preferably through the use of a joining technique. The illustrated channels 28 preferably extend from an end surface 21 of the honeycomb structure in the axial direction 3 through the entire filter body 25. In this context, freedom of flow means that in any desired cross section it is possible to see through at least 20% of the area, i.e. at least 20% of the area is free of internals such as, for example, the vanes 6 or the like. In other words, this also means that, when a filter body 25 of this type is viewed from the end, it is possible to at least partially see through the channels 28, provided that all of the internals are in approximately the same installation position, i.e. are aligned one behind the other. This is typically the case in honeycomb bodies having at least partially structured sheet-metal layers. However, in the case of internals which are not aligned with one another, the freedom of flow does not necessarily mean that one can actually see through part of a honeycomb body of this type. In this respect, a non-illustrated direction of flow 39 substantially parallel to the channels 28 is superimposed. The vanes 6 which are disposed in accordance with the invention in a non-illustrated manner lead to a secondary flow 41, which is generally somewhat locally limited. In the case of a helically wound foil 1 and filter layer 27, it is possible to determine a secondary flow 41 which runs substantially in the radial direction 37.

FIG. 8 shows a perspective and diagrammatic illustration of a further configuration of a filter body 25. The filter body 25 has a diameter 36 (in the radial direction 37) and a length 35 (in the axial direction 3), as well as a volume 34 which results substantially from the diameter 36 and the length 35. The embodiment of the filter 25 which is illustrated has a plurality of foils 1 and filter layers 27 which are wrapped around one another in semicircular form. It can be seen from this figure that the configuration of the foils 1 and of the filter layers 27 has a considerable influence on the secondary flow 41 which is thereby generated. While in the embodiment illustrated in FIG. 7, a gas stream which flows-in centrally is guided primarily radially outward, in the embodiment illustrated in FIG. 8 it is possible to recognize regions in which the secondary flow 41 locally runs in the opposite direction.

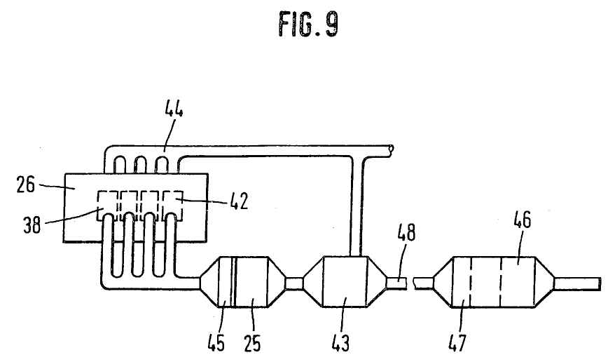

FIG. 9 diagrammatically depicts the structure of an exhaust system as is used, for example, to clean exhaust gases from mobile motor vehicle engines. An internal combustion engine 26, in particular a diesel engine, is supplied with a fuel/air mixture through a feed 44, and this mixture is burned in combustion chambers 42. The combustion chambers 42 each have a combustion chamber volume which overall results in what is known as a displacement volume 38. The exhaust gases which are formed during the combustion are fed through an exhaust pipe 48 to various components of the exhaust system before being discharged to the environment in the clean state. In the illustrated embodiment, the exhaust gas initially passes through an oxidation catalytic converter 45 and a filter body 25 according to the invention which directly adjoins it. Then, the exhaust gas is passed to a turbo charger 43, which compresses the fresh air supplied to the internal combustion engine 26 with the aid of the exhaust gas. Then, the exhaust gas is passed on to a catalytic converter 46, which is preferably disposed on the underside of a motor vehicle. This catalytic converter 46 may be constructed with different zones 47 which, by way of example, differ in terms of their surface-specific heat capacity and/or their catalytic coating. However, the illustrated exhaust system may also be supplemented by. further components such as, for example, what are known as adsorbers for adsorbing nitrogen oxide or long-chain hydrocarbons, electrically heatable honeycomb bodies for heating the exhaust gas during the cold-start phase, sensors for determining the composition of the exhaust gas, secondary air supply in a region of the exhaust pipe or the like.

We claim:

1. A filter body for cleaning exhaust gases from an internal combustion engine, the filter body comprising:
at least one filter layer and at least one foil together forming channels through which the exhaust gas can flow;
said at least one foil having a structure with a structure height;
said structure having elevations and depressions extended at least partially in an axial direction;
said at least one foil having a plurality of vanes with a vane height, said vane height being between 100% and 60% of said structure height, ensuring a freedom of flow of at least 20%; and
each of said vanes forming a passage having a vane inlet and a vane outlet, said vane inlet and said vane outlet being oriented at an angle to one another.

2. The filter body according to claim 1, wherein said vanes are disposed in at least a plurality of said elevations and in at least a plurality of said depressions, and said vanes include vanes being directly adjacent each other in the axial direction, said directly adjacent vanes being offset with respect to one another in a transverse direction.

3. The filter body according to claim 2, wherein each of said vanes disposed on one of said elevations is disposed directly adjacent a respective one of said vanes disposed in one of said depressions, in radial direction of said at least one foil.

4. The filter body according to claim 3, wherein said vanes being offset with respect to one another in the transverse direction have an offset of 2 to 5 mm.

5. The filter body according to claim 1, wherein said vane inlet is disposed substantially perpendicular to the axial direction.

6. The filter body according to claim 1, wherein said flow inlet is disposed upstream of said flow outlet, as seen in the axial direction, in all of said vanes.

7. The filter body according to claim 1, wherein each of said vanes has a collar.

8. The filter body according to claim 7, wherein said collar has a collar width of 0.5 mm to 5 mm.

9. The filter body according to claim 1, wherein each of said vanes has a guide surface.

10. The filter body according to claim 9, wherein said guide surface has an extent of 1.5 mm to 10 mm in the axial direction.

11. The filter body according to claim 9, wherein said guide surface forms a vane angle with the axial direction.

12. The filter body according to claim 11, wherein said vane angle lies in a range of from 15° to 30°.

13. The filter body according to claim 9, wherein said guide surface has at least one aperture formed therein in addition to said vane inlet and said vane outlet.

14. The filter body according to claim 13, wherein said at least one aperture is smaller than at least one of said vane inlet and said vane outlet.

15. The filter body according to claim 1, wherein said structure has a structure width, and a ratio of said structure width to said structure height lies in a range between 1 and 3.

16. The filter body according to claim 1, wherein at least four of said vanes are disposed one behind the other in the axial direction.

17. The filter body according to claim 16, wherein at least six of said vanes are disposed one behind the other in the axial direction.

18. The filter body according to claim 16, wherein said vanes disposed one behind the other in the axial direction are at a distance of from 5 to 30 mm from one another.

19. The filter body according to claim 1, wherein said at least one foil has a foil thickness of less than 0.06 mm.

20. The filter body according to claim 19, wherein said at least one foil is formed of a corrosion-resistant and heat-resistant material.

21. The filter body according to claim 19, wherein said at least one foil is formed of a corrosion-resistant and heat-resistant metal.

22. The filter body according to claim 1, wherein said at least one filter layer has a mean porosity of between 50% and 95%.

23. The filter body according to claim 1, wherein said at least one filter layer has a mean porosity of between 75% and 90%.

24. The filter body according to claim 1, wherein said at least one filter layer has a filter layer thickness of 0.2 mm to 1.5 mm.

25. The filter body according to claim 24, wherein said at least one filter layer is formed of a fiber material with a mean fiber diameter of from 5 μm to 20 μm.

26. The filter body according to claim 1, wherein said at least one filter layer and said at least one foil are at least one of stacked and wound to form a honeycomb body, and a housing at least partially surrounds said honeycomb body.

27. The filter body according to claim 1, wherein the filter body has a volume lying in a range of from 0.01 liter to 1 liter.

28. The filter body according to claim 1, wherein the filter body has a volume being less than a displacement volume of the internal combustion engine.

29. The filter body according to claim 1, wherein the filter body has a length and a diameter, and a ratio of said length to said diameter is between 0.5 and 2.5.

30. The filter body according to claim 1, wherein the filter body has a channel density between 50 and 500 cpsi.
